(19) United States
(12) Patent Application Publication
(10) Pub. No.: US 2007/0135154 A1
(43) Pub. Date: Jun. 14, 2007

(54) Method and system for controlling transmitter power using antenna loading on a multi-antenna system

(75) Inventors: Roberto Gautier, Davie, FL (US); Jason T. Young, Palm City, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/300,071

(22) Filed: Dec. 14, 2005

(51) Int. Cl. H04B 1/02; H04B 7/00

(52) U.S. Cl. 455/522; 455/101

(57) ABSTRACT

A system (100) and method (200) of controlling transmit power in a mobile wireless device (101) can include a plurality of transmitters (103, 105, 107), a plurality of antennas (102,104,116) correspondingly coupled to the plurality of transmitters, and a processor (114) coupled to the plurality of transmitters. The processor can be programmed to measure (202) a loading characteristic on a first antenna (102) coupled to a first transmitter (103) and modify (206) a transmitter power on at least a second transmitter (107) based on the loading characteristic measured on the first antenna. The processor can be further programmed to limit (208) the transmitter power on the second transmitter (105) if the loading characteristic measured on the first antenna exceeds a predetermined threshold and to enable (210) a tuned power setting for the second transmitter if the loading characteristic measured on the first antenna falls below a predetermined threshold.

### FIELD

This invention relates generally to transmitter control methods and systems, and more particularly to a method and system of controlling transmitter power based on antenna loading.

### BACKGROUND

Code Division Multiple Access (CDMA) cellular phones typically cannot transmit at full rated power and meet the Federal Communication Commission (FCC) specific absorption rate (SAR) limits with the phone placed against the ear. In order to meet these requirements in many existing products, the power is set or limited to the highest level that will still allow the phone to meet the FCC's SAR requirement. There is no provision in existing products to enable the power to increase when the phone is moved away from the ear since a means for indicating such condition to the transmitter controller has not been implemented. When the phone is not against the head, existing phones use the same transmitter power setting since the user might place the phone against their head at any time.

### SUMMARY

Embodiments in accordance with the present invention can enable a cellular phone or other wireless device to increase transmitter power dynamically based on knowledge of antenna loading in a multi-antenna system.

In a first embodiment of the present invention, a method of controlling transmit power in a multiple-antenna system in a mobile wireless device can include the steps of measuring a loading characteristic on a first antenna coupled to a first transmitter in the mobile wireless device and modifying a transmitter power on at least a second transmitter having a separate antenna based on the loading characteristic measured on the first antenna. The step of measuring the loading characteristic on the first antenna can include measuring a phase train squiggle, a pseudo train ramp, or a full train amplitude ramp. The method can further include limiting the transmitter power on the second transmitter if the loading characteristic measured on the first antenna exceeds a predetermined threshold. The method can further include enabling a tuned power setting for the second transmitter if the loading characteristic measured on the first antenna falls below a predetermined threshold. The method can further include limiting the transmitter power or enabling a tuned power setting on the second transmitter if a significant shift in the loading characteristic is detected during the step of measuring. The method can optionally modify a transmitter power on the first transmitter based on the loading characteristic measured on the first antenna. The method can further optionally modifying a transmitter power on the first transmitter based on a loading characteristic measured on at least the second antenna.

In a second embodiment of the present invention, a system of controlling transmit power in a mobile wireless device can include a plurality of transmitters, a plurality of antennas correspondingly coupled to the plurality of transmitters in the mobile wireless device, and a processor coupled to the plurality of transmitters. The processor can be programmed to measure a loading characteristic on a first antenna coupled to a first transmitter in the mobile wireless device and modify a transmitter power on at least a second transmitter having a separate antenna based on the loading characteristic measured on the first antenna. The processor can measure the loading characteristic in a number of ways including measuring a phase train squiggle, a pseudo train ramp, or a full train amplitude ramp. The processor can be further programmed to limit the transmitter power on the second transmitter if the loading characteristic measured on the first antenna exceeds a predetermined threshold and to enable a tuned power setting for the second transmitter if the loading characteristic measured on the first antenna falls below a predetermined threshold. The processor can also be programmed to limit the transmitter power or enable a tuned power setting on the second transmitter if a significant shift in the loading characteristic is detected during a measuring of the loading characteristic. Optionally, the processor can be further programmed to modify a transmitter power on the first transmitter based on the loading characteristic measured on the first antenna or the processor can be further programmed to modify a transmitter power on the first transmitter based on a loading characteristic measured on at least the second antenna.

In a third embodiment of the present invention, a mobile wireless device can include a first transmitter, a first antenna coupled to the first transmitter, at least a second transmitter coupled to at least a second antenna, and a processor coupled to the first transmitter and at least the second transmitter. The processor can be programmed to measure a loading characteristic on the first antenna and modify a transmitter power on at least the second transmitter based on the loading characteristic measured on the first antenna. Although not limited to such an arrangement, the first transmitter can be a portion of a TDMA-based transceiver and the second transmitter can be a portion of a CDMA-based transceiver or vice-versa. The processor can measure the loading characteristic on the first antenna in a number of ways including by measuring a phase train squiggle, a pseudo train ramp, or a full train amplitude ramp. The processor can be further programmed to limit the transmitter power on the second transmitter if the loading characteristic measured on the first antenna exceeds a predetermined threshold or can enable a tuned power setting for the second transmitter if the loading characteristic measured on the first antenna falls below a predetermined threshold. The processor can be further programmed to limit the transmitter power or enable a tuned power setting on the second transmitter if a significant shift in the loading characteristic is detected during a measuring of the loading characteristic.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a system for controlling transmit power in a mobile wireless device in accordance with an embodiment of the present invention.

FIG. 2 is a flow chart illustrating a method for controlling transmit power in a mobile wireless device in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

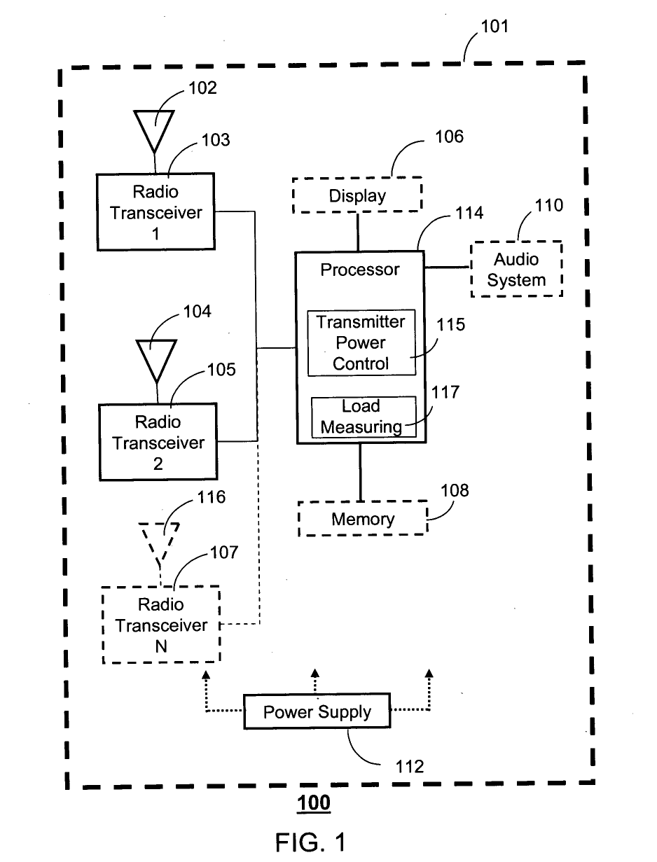

Referring to FIG. 1, a wireless device 101 such a multi-antenna radio in a communication system 100 can be implemented in the form of a lap top computer or a cellular phone or any other electronic device. The electronic device can further include a display 106 for conveying images to a user of the device, a memory 108 including one or more storage elements (e.g., Static Random Access Memory, Dynamic RAM, Read Only Memory, etc.), an optional audio system 110 for conveying audible signals (e.g., voice messages, music, etc.) to the user of the device, a conventional power supply 112 for powering the components of the device, and a processor 114 comprising one or more conventional microprocessors and/or digital signal processors (DSPs) for controlling operations of the foregoing components.

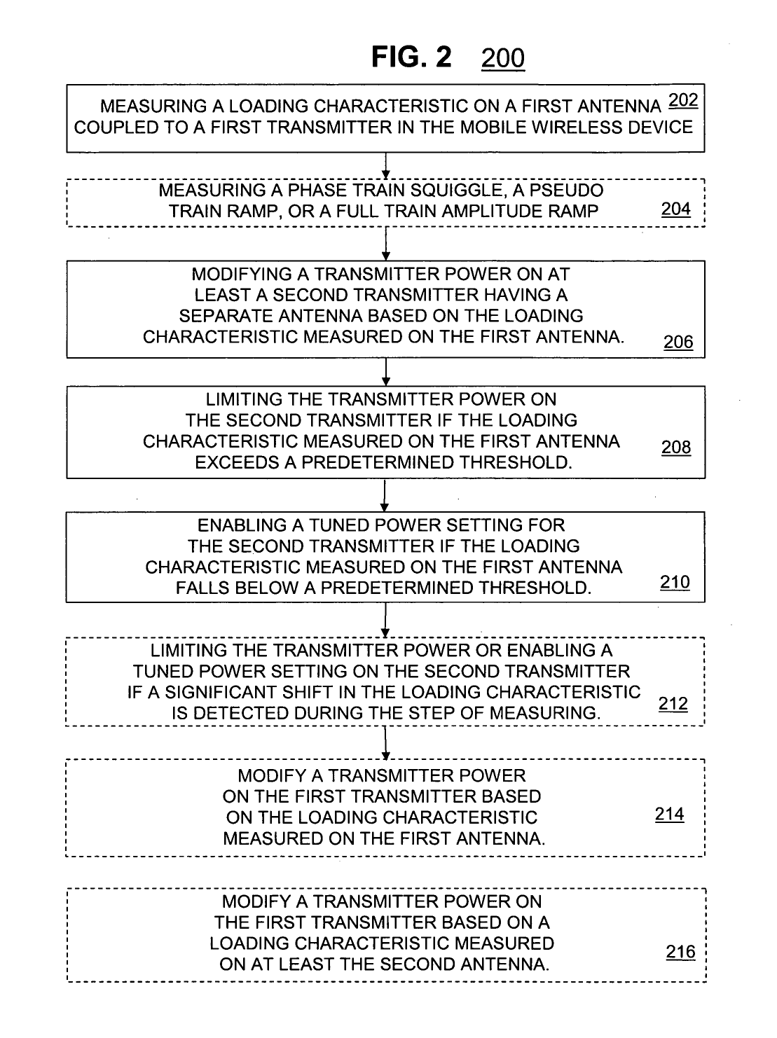

The processor 14 can be programmed to operate as further described with respect to the flow chart of FIG. 2 and can include a transmitter power control portion 115 and a load measuring portion 117. The processor 114 can be coupled to a plurality of transceivers (103, 105, and 107) including a first radio transceiver 103 and a second radio transceiver 105. Of course, the processor 114 can be coupled to any number of additional transceivers 107. Each of the transceivers 103, 105, and 107 can be coupled to respective antennas 102,104 and 116.

In one embodiment using a dual transceiver system that implements dual antennas 102 and 104, the diagnostic data of one transmitter 103 can be used to estimate the antenna loading of the second transmitter 105. This estimate can then be used to adjust the second transmitter's power to maximize a network link. If the antenna (102 or 104) is loaded, the phone is assumed to be near the head (or some other object) and the power can be set to a level that allows the phone to pass the SAR limit as if it was located next to the ear. If the antenna (102 or 104) is not loaded, the phone is assumed to be in free space and the power can be set to the highest allowable output power with a greatly diminished concern about exceeding the SAR requirement since SAR levels are drastically reduced over free space.

In one particular embodiment, the first transceiver 103 can be implemented as an iDEN transceiver having the antenna 102 in the form of a retractable antenna and the second transceiver 105 can be implemented as a CDMA transceiver having the antenna 104 as an internal antenna. Since there is limited antenna to antenna isolation (due to the co-location of both antennas within the wireless device 101), any loading of one antenna by an external stimulus will affect the other antenna as well, thus affecting the functionality of the transmitter and changing its diagnostic registers. Sensing the change of diagnostic registers on one transmitter can be used to make decisions on the secondary transmitter and increase/decrease the output power settings as needed.

In one implementation, using the iDEN transmitter “training” information, an estimation of the phone's antenna load can be performed. If the antenna is considered to be in “free space”, the amplitude of the iDEN “training” parameters (phase train squiggle, pseudo train ramp and/or full train amplitude ramp) will be the same as when tested in a factory environment. Once the antenna is “loaded” by coming within proximity of an object, a shift in the amplitude of the parameters can be measured. Once a significant shift on the mentioned parameters is measured at antenna 102 (or other antennas 104 or 116 in other embodiments), an assumption can be made that the antennas have been loaded. Once this happens, the transceiver 105 using the internal antenna can shift from the “tuned power” setting to a lower “SAR limited” power setting. If the transmitter 103 on the retractable antenna (102) is operating in a “free space” environment (this can be estimated by reading the diagnostic registers as discussed above), then it can be assumed that the internal antenna (104) will be in “free space” as well due to co-location. In this case the “tuned power setting” can be used since the phone is not in a “SAR limited” case. Implementing this method, the transceiver (105) using the internal antenna (104) can have better up-link margin since it can be transmitting at a higher power instead of being “taxed” with the “SAR limited” power setting all the time.

Operationally, the system 100 can operate in accordance a method 200 of controlling transmit power in a multiple-antenna system in a mobile wireless device as illustrated in the flow chart of FIG. 2. The method 200 can include the step 202 of measuring a loading characteristic on a first antenna coupled to a first transmitter in the mobile wireless device and modifying at step 206 a transmitter power on at least a second transmitter having a separate antenna based on the loading characteristic measured on the first antenna. The step 202 of measuring the loading characteristic on the first antenna can include measuring a phase train squiggle, a pseudo train ramp, or a full train amplitude ramp at step 204. The method 200 can further include the step 208 of limiting the transmitter power on the second transmitter if the loading characteristic measured on the first antenna exceeds a predetermined threshold. The method 200 can further include step 210 of enabling a tuned power setting for the second transmitter if the loading characteristic measured on the first antenna falls below a predetermined threshold. The method 200 can optionally limit the transmitter power or enable a tuned power setting on the second transmitter if a significant shift in the loading characteristic is detected at step 212 during the measuring of the loading characteristic. The method 200 can also optionally modify a transmitter power on the first transmitter based on the loading characteristic measured on the first antenna at step 214. As shown at step 216, any measurement of antenna loading at any one of the plurality of antennas can be used to modifying transmitter power at another corresponding transmitter. Thus, the method 200 can optionally modifying a transmitter power on the first transmitter based on a loading characteristic measured on at least the second antenna at step 216.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of controlling transmit power in a multiple-antenna system in a mobile wireless device, comprising the steps of:
measuring a loading characteristic on a first antenna coupled to a first transmitter in the mobile wireless device; and
modifying a transmitter power on at least a second transmitter having a separate antenna based on the loading characteristic measured on the first antenna.

2. The method of claim 1, wherein the step of measuring the loading characteristic on the first antenna comprises the step of measuring a phase train squiggle, a pseudo train ramp, or a full train amplitude ramp.

3. The method of claim 1, wherein the method further comprises the step of limiting the transmitter power on the second transmitter if the loading characteristic measured on the first antenna exceeds a predetermined threshold.

4. The method of claim 1, wherein the method further comprises the step of enabling a tuned power setting for the second transmitter if the loading characteristic measured on the first antenna falls below a predetermined threshold.

5. The method of claim 1, wherein the method further comprises the step of limiting the transmitter power or enabling a tuned power setting on the second transmitter if a significant shift in the loading characteristic is detected during the step of measuring.

6. The method of claim 1, wherein the method further comprises the step of modifying a transmitter power on the first transmitter based on the loading characteristic measured on the first antenna.

7. The method of claim 1, wherein the method further comprises the step of modifying a transmitter power on the first transmitter based on a loading characteristic measured on at least the second antenna.

8. A system of controlling transmit power in a mobile wireless device, comprising:
a plurality of transmitters;
a plurality of antennas correspondingly coupled to the plurality of transmitters in the mobile wireless device; and
a processor coupled to the plurality of transmitters, wherein the processor is programmed to:
measure a loading characteristic on a first antenna coupled to a first transmitter in the mobile wireless device; and
modify a transmitter power on at least a second transmitter having a separate antenna based on the loading characteristic measured on the first antenna.

9. The system of claim 8, wherein the processor measures the loading characteristic on the first antenna by measuring a phase train squiggle, a pseudo train ramp, or a full train amplitude ramp.

10. The system of claim 8, wherein the processor is further programmed to limit the transmitter power on the second transmitter if the loading characteristic measured on the first antenna exceeds a predetermined threshold.

11. The system of claim 8, wherein the processor is further programmed to enable a tuned power setting for the second transmitter if the loading characteristic measured on the first antenna falls below a predetermined threshold.

12. The system of claim 8, wherein the processor is further programmed to limit the transmitter power or enable a tuned power setting on the second transmitter if a significant shift in the loading characteristic is detected during a measuring of the loading characteristic.

13. The system of claim 8, wherein the processor is further programmed to modify a transmitter power on the first transmitter based on the loading characteristic measured on the first antenna.

14. The system of claim 8, wherein the processor is further programmed to modify a transmitter power on the first transmitter based on a loading characteristic measured on at least the second antenna.

15. A mobile wireless device, comprising:
a first transmitter;
a first antenna coupled to the first transmitter;
at least a second transmitter coupled to at least a second antenna; and
a processor coupled to the first transmitter and at least the second transmitter, wherein the processor is programmed to:
measure a loading characteristic on the first antenna; and
modify a transmitter power on at least the second transmitter based on the loading characteristic measured on the first antenna.

16. The mobile wireless device of claim 15, wherein the first transmitter is a portion of a TDMA-based transceiver and the second transmitter is a portion of a CDMA-based transceiver.

17. The mobile wireless device of claim 15, wherein the processor measures the loading characteristic on the first antenna by measuring a phase train squiggle, a pseudo train ramp, or a full train amplitude ramp.

18. The mobile wireless device of claim 15, wherein the processor is further programmed to limit the transmitter power on the second transmitter if the loading characteristic measured on the first antenna exceeds a predetermined threshold.

19. The mobile wireless device of claim 15, wherein the processor is further programmed to enable a tuned power setting for the second transmitter if the loading characteristic measured on the first antenna falls below a predetermined threshold.

20. The mobile wireless device of claim 15, wherein the processor is further programmed to limit the transmitter power or enable a tuned power setting on the second transmitter if a significant shift in the loading characteristic is detected during a measuring of the loading characteristic.
